(19) United States
(12) Patent Application Publication
(10) Pub. No.: US 2009/0147634 A1
(43) Pub. Date: Jun. 11, 2009

(54) OPTICAL PICKUP APPARATUS AND INFORMATION RECORDING AND REPRODUCING APPARATUS

(75) Inventor: Shinnosuke Torii, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/326,638

(22) Filed: Dec. 2, 2008

(30) Foreign Application Priority Data
Dec. 11, 2007 (JP) 2007-319853

(51) Int. Cl. G11B 7/00

(52) U.S. Cl. 369/47.5; G9B/7

(57) ABSTRACT

A light quantity adjusting apparatus, to adjust a light quantity of a light beam emitted from a light source, including a transmission element, including a first transmission portion, formed on a plane, having a first transmittance and a second transmission portion, formed on the same plane as the first transmission portion, having a second transmittance, a support element to support the transmission element, and a rotation shaft, connected to the support element, with a center axis extending in a direction perpendicular to an optical axis of the light beam, to rotate the transmission element, supported by the support element, about the center axis, to selectively insert into a path of the light beam one of the first transmission portion and the second transmission portion to adjust the light quantity of the light beam passing through a respective transmission portion.

### BACKGROUND OF THE INVENTION

1. Field of the Invention

The present invention relates to an information recording and reproducing apparatus adapted for optical discs, such as a CD, a DVD, and a Blu-ray Disc, and to an optical pickup apparatus for use in the information recording and reproducing apparatus.

2. Description of the Related Art

A DVD (Digital Versatile Disc) is known as an information recording medium (optical disc), which can record digital data at a recording density about six times that obtainable with a CD (Compact Disc Interactive) and which can write, therein, large-capacity digital data, such as movies and music. Recently, the amount of information to be recorded has increased and an information recording medium with a larger capacity has been demanded.

In order to increase the capacity of the information recording medium, such as the optical disc, the information recording density has to be increased. The information recording density can generally be increased by reducing a spot diameter of a laser beam radiated to the optical disc when data is written to and read from the optical disc. The beam spot diameter can be reduced by using a laser beam having a shorter wavelength and increasing the numerical aperture (NA) of an objective lens. By using a blue laser beam with a wavelength of 405 nm and an objective lens with the NA of 0.85, for example, information can be recorded at a density about five times that obtainable with the current DVD.

In addition to the use of a blue laser beam, etc., for shortening the wavelength of the laser beam, a technique of providing a plurality of recording layers in one optical disc has also been developed to further increase the recording density. For example, if an optical disc having two recording layers is realized, the recording density becomes about ten times that obtainable with the DVD having one recording layer, in combination with the use of the laser beam having a shorter wavelength and an objective lens having a larger NA value.

In an optical disc drive apparatus using a blue laser as a light source, however, the blue laser has a very small margin for optical power used to reproduce data, and the light source suffers from a problem of quantum noise.

To overcome such a problem, Japanese Patent Laid-Open No. 2006-40432 discloses an optical disc drive apparatus in which an optical pickup apparatus includes, as a light quantity adjusting unit, a light beam transmission adjusting unit (i.e., an intensity filter) which is rotated to be selectively inserted into a path of the laser beam.

FIGS. 3 and 4 illustrate the related art.

FIG. 3 is a functional block diagram of a known optical disc drive apparatus 10. The optical disc drive apparatus 10 includes an optical pickup apparatus 11, a signal processing circuit 12, and a servo control circuit 13.

First, the operation of the optical disc drive apparatus 10 is summarized below. The optical pickup apparatus 11 radiates a light beam toward an optical disc 14 and detects the light reflected from the optical disc 14. Further, the optical pickup apparatus 11 outputs a light quantity signal depending on the detected position of the reflected light and the quantity of the detected light. On the basis of the light quantity signal output from the optical pickup apparatus 11, the signal processing circuit 12 generates and outputs, for example, a focusing error (FE) signal representing a focused state of the light beam on the optical disc 14, and a tracking error (TE) signal, representing the positional relationship between a focused position of the light beam and a track on the optical disc 14. The FE signal and the TE signal are collectively called servo signals. The servo control circuit 13 generates and outputs a drive signal on the basis of the servo signals. The drive signal is input to an actuator coil 6 (described later) of the optical pickup apparatus 11, whereupon the position of an objective lens 5 is adjusted. As a result, the focus of the light beam radiated toward the optical disc 14 is controlled in order to keep the light beam from departing from a recording layer.

In the state where the focus of the light beam is controlled to be kept from departing from the recording layer, the signal processing circuit 12 outputs a reproduced signal on the basis of the light quantity signal. The reproduced signal represents data written to the optical disc 14. As a result, data read from the optical disc 14 can be realized. Also, data can be written to the optical disc 14 by setting the optical power of the light beam to be greater than that necessary for reproducing.

The construction of the optical pickup apparatus 11 will be described below. A light beam transmission adjusting unit 100 has two transmission elements having different light transmittances, and can adjust the optical power of the light beam by rotating the two transmission elements to be selectively inserted into an optical path.

The optical pickup apparatus 11 includes an optical source 1, the light beam transmission adjusting unit 100, a beam splitter 2, a collimator lens 3, a mirror 4, the objective lens 5, the actuator coil 6, a multi-lens 7, and a photodiode 8.

The light source 1 is a GaN-based semiconductor laser emitting blue light. The light source 1 emits, toward the recording layer on the optical disc 14, coherent light for reading and writing data.

The detailed construction of the light beam transmission adjusting unit 100 will be described with reference to FIGS. 4A and 4B.

FIG. 4A is a perspective view of the light beam transmission adjusting unit 100 when a light beam 20 passes through an optical filter of the light beam transmission adjusting unit 100. FIG. 4B is a perspective view of the light beam transmission adjusting unit 100 when the light beam 20 does not pass through the optical filter of the light beam transmission adjusting unit 100. The optical beam 20 advances in the direction denoted by an arrow.

The light beam transmission adjusting unit 100 includes a first transmission element 101, a second transmission element 102, a rotation shaft 103, a support unit 104, and a rotating unit 105. The first transmission element 101 is coated with an optical filter 101a having a transmittance of 50% and attenuates the optical power of the light beam passing through it. On the other hand, the second transmission element 102 is coated with no optical filter and allows the light beam 20 to pass through it, substantially maintaining the optical power of the light beam. The support unit 104 supports the first transmission element 101 and the second transmission element 102 to be rotatable about the rotation shaft 103. The rotation shaft 103 is extended parallel to the first transmission element 101 and the second transmission element 102. In other words, the rotation shaft 103 is disposed to extend perpendicularly to the direction in which the light beam 20 advances. The rotating unit 105 rotates the first transmission element 101 and the second transmission element 102 about the rotation shaft 103.

By operating the rotating unit 105 to rotate the first transmission element 101 and the second transmission element 102 about the rotation shaft 103, the light beam transmission adjusting unit 100 can selectively take a state of allowing the light beam 20 to pass through the first transmission element 101 (FIG. 4A) or a state of allowing the light beam 20 to pass through the second transmission element 102 (FIG. 4B). Stated another way, the light beam transmission adjusting unit 100 can selectively change the state where the light beam 20 passes through the optical filter 101a and the state where the light beam 20 does not pass through the optical filter 101a. The optical power of the light beam 20 when passing through the optical filter 101a is 50% of the optical power when the light beam 20 does not pass through the optical filter 101a.

Referring to FIG. 3 again, the beam splitter 2 separates the light beam emitted from the light source 1. The collimator lens 3 converts the light beam emitted from the light source 1 to parallel light. The mirror 4 reflects the incident light beam to be directed toward the optical disc 14. The objective lens 5 focuses the light beam onto the recording layer of the optical disc 14. The actuator coil 6 changes the position of the objective lens 5 in a direction perpendicular to the optical disc 14 or a direction parallel to the optical disc 14, depending on a level of the applied drive signal. The multi-lens 7 focuses the light beam onto the photodiode 8. The photodiode 8 receives the light beam reflected by the recording layer of the optical disc 14 and converts the received light beam to an electrical signal (light quantity signal) corresponding to the light quantity of the received light beam. The photodiode 8 may include a plurality of light-receiving devices. The signal processing circuit 12 receives the light quantity signal and generates the FE signal and the TE signal, by additionally utilizing information indicating from which one of the light-receiving devices the light quantity signal is output.

The operations of the optical disc drive apparatus 10 for reading and writing data will be described below. It is here assumed that, when the optical disc 14 has two recording layers, the transmittance of one recording layer, positioned nearer to the objective lens 5, is set to about 50%. In such a case, therefore, the intensity of the optical power required for recording and reproducing data on and from the optical disc, having two recording layers, is about twice that required for the optical disc having one recording layer. Thus, the following description is made on the assumption that the optical pickup apparatus 11 of the related art has the function of selectively changing the intensity of the optical power depending on whether the optical disc 14 has one or two recording layers.

First, the light source 1 emits a light beam having a predetermined intensity of optical power. At that time, the light beam transmission adjusting unit 100 is assumed to take the state where the light beam passes through the optical filter 101a. The light beam outgoing from the light beam transmission adjusting unit 100 is reflected by the beam splitter 2, converted to parallel light by the collimator lens 3, and reflected by the mirror 4. Then, the light beam is focused by the objective lens 5 onto the recording layer of the optical disc 14. The reflected light from the recording layer passes through the optical pickup apparatus 11 and enters the photodiode 8. The signal processing circuit 12 determines the number of recording layers of the optical disc 14 depending on the magnitude of the resulting light quantity signal. The process of determining the number of recording layers of the optical disc 14 can also be performed by using other various methods. For example, identification information for specifying the number of recording layers is recorded in an inner peripheral area of the optical disc 14 in a manufacturing stage, and the identification information is read as a reproduced signal to specify the number of recording layers. As an alternative, taking into account the fact that when the laser beam is irradiated to recording media, the intensity of reflected light differs depending on the types of the recording media, the signal processing circuit 12 determines the number of recording layers by detecting the intensity of the reflected light. Further, when the optical disc 14 is loaded in a state contained in a cartridge, the number of recording layers can be determined by checking the shapes of cartridges, which differ from each other, depending on the types of the optical discs 14. Anyway, the number of recording layers of the optical disc 14 can be detected by utilizing optical characteristics and/or physical characteristics of the optical disc loaded in place.

When it is determined that the optical disc 14 has one recording layer, the light beam transmission adjusting unit 100 is operated to rotate the first transmission element 101 and the second transmission element 102, such that the first transmission element 101 is positioned perpendicularly to an optical axis and the second transmission element 102 is positioned away from the optical path. Therefore, the light beam passes through the optical filter 101a on the first transmission element 101, while the optical filter 101a attenuates the optical power of the incident light beam to about 50%.

On the other hand, when it is determined that the optical disc 14 has two recording layers, the light beam transmission adjusting unit 100 is operated to rotate the first transmission element 101 and the second transmission element 102, such that the second transmission element 102 is positioned perpendicularly to the optical axis and the first transmission element 101 is positioned away from the optical path. Thus, the second transmission element 102 causes the incident light beam to pass through it without substantially attenuating the optical power of the light beam.

When data is written, the state of the recording layer in an area where a light spot is formed, is changed, depending on the substance of the data. When data is read, the light beam is reflected at a reflectivity that depends on the state of the recording layer of the optical disc 14. The light beam reflected by the recording layer passes through the objective lens 5 again, and is reflected by the mirror 4. After passing through the collimator lens 3 and then the multi-lens 7, the light beam is focused onto the photodiode 8. As a result, the photodiode 8 generates and outputs the light quality signal. On the basis of the light quantity signal, the signal processing circuit 12 generates the reproduced signal representing the substance of the written data, the focusing error signal, the tracking error signal, etc.

Meanwhile, there has recently been a demand for optical disc drive apparatuses to not only realize reduction in size, thickness and cost, but also, to have a larger performance margin for a severe operating environment of a mobile apparatus. In particular, such a demand is significant in products called Camcorders, i.e., video cameras combined with recorders, which have been increasingly used in recent years.

Generally, when temperature rises, quantum noise of a light source is increased. In Camcorders, a heat generating source, such as an electrical circuit board, and the optical disc drive apparatus, are arranged at a high density to realize a smaller product. That arrangement necessarily promotes a temperature rise of the optical disc drive apparatus. However, it is difficult to employ a fan for cooling the apparatus, in order to avoid an increase in the size and the cost of the apparatus.

Further, in Camcorders, the optical disc drive apparatus tends to be often subjected to, for example, the difference in posture and application of an impact, in use. This is because, for example, a possibility that a user of the Camcorder abruptly changes the shooting direction or that the user's hand hits against the apparatus during the image-taking operation, is greatly larger than other products, such as a personal computer and a video recorder, which are used in an environment where the apparatus is kept stationary.

Thus, coping with an increase of quantum noise in the light source, and ensuring a performance margin in the apparatus at the same time, are important in increasing an added value of the product itself.

However, the above-described related art has the following problems.

In the light beam transmission adjusting unit 100 of the related art, the first transmission element 101 and the second transmission element 102 need to be fixed to the support unit 104 in a perpendicularly crossed state. This means that, from the viewpoint of part machining, variations in mounting angles are caused in a mounting portion of the first transmission element 101 to the support unit 104, and a mounting portion of the second transmission element 102 to the support unit 104. In other words, the first transmission element 101 and the second transmission element 102 have an angular variation. Accordingly, when the transmission elements are selectively changed from one to the other in the related art, as described above, a deviation of the optical axis is generated due to an angular deviation of each transmission element with respect to the optical axis of the light beam passing through the relevant transmission element. Accordingly, the light beam reflected by the recording layer of the optical disc 14 is focused on the photodiode 8 at positions deviated from each other. Such a deviation of the focused position deteriorates signal quality of the servo signals, such as the focusing error signal and the tracking error signal, and also deteriorates quality of the reproduced signal and the recording signal recorded on the optical disc 14.

### SUMMARY OF THE INVENTION

In view of the above-described problems with the related art, an exemplary embodiment of the present invention provides an optical pickup apparatus, including a light quantity adjusting unit, which can suppress deterioration of signal quality without increasing the number of parts.

A light quantity adjusting apparatus, according to one aspect of the present invention, includes a transmission element including a first transmission portion, formed on a plane, having a first transmittance and a second transmission portion, formed on the same plane as the first transmission portion, having a second transmittance. The apparatus further includes a support element to support the transmission element, and a rotation shaft, connected to the support element, with a center axis extending in a direction perpendicular to an optical axis of the light beam, to rotate the transmission element, supported by the support element, about the center axis to selectively insert into a path of the light beam one of the first transmission portion and the second transmission portion to adjust the light quantity of the light beam passing through a respective transmission portion.

In another aspect of the invention, the apparatus described above is included in an optical pickup apparatus further comprising a light source for emitting a light beam and an objective lens to focus the light beam, having the adjusted light quantity, from the light quantity adjusting mechanism to an information recording medium.

In another aspect of the present invention, an apparatus for effecting at least one of recording and reproducing information, includes the optical pickup apparatus described above, and a photodiode to receive a light beam reflected from the information recording medium and to convert the received light beam to a light quantity signal output and a signal processing circuit. The signal processing circuit is configured to output, based on the light quantity signal output, a focusing error signal, representing a focused state of a light beam on the information recording medium, and a tracking error signal, representing a positional relationship between a focused position of the light beam and a track on the information recording medium.

With the exemplary embodiment of the present invention, a deviation of the optical axis of the light beam transmitting through the transmission element is reduced which is caused by an angular variation between the first transmission portion and the second transmission portion. Therefore, a deviation of the position where the light beam reflected by a recording layer of the information recording medium (optical disc) focuses on a photodiode is also reduced. As a result, deterioration in quality of servo signals, a reproducing signal, and a recording signal is reduced.

Further features of the present invention will become apparent from the following description of exemplary embodiments, with reference to the attached drawings.

### BRIEF DESCRIPTION OF THE DRAWINGS

FIGS. 1A and 1B are each a functional block diagram of an optical disc drive apparatus circuit according to an exemplary embodiment of the present invention.

FIGS. 2A to 2D illustrate the structure of a light quantity adjusting mechanism in the exemplary embodiment of the present invention.

FIG. 3 is a functional block diagram of an optical disc drive apparatus circuit of the related art.

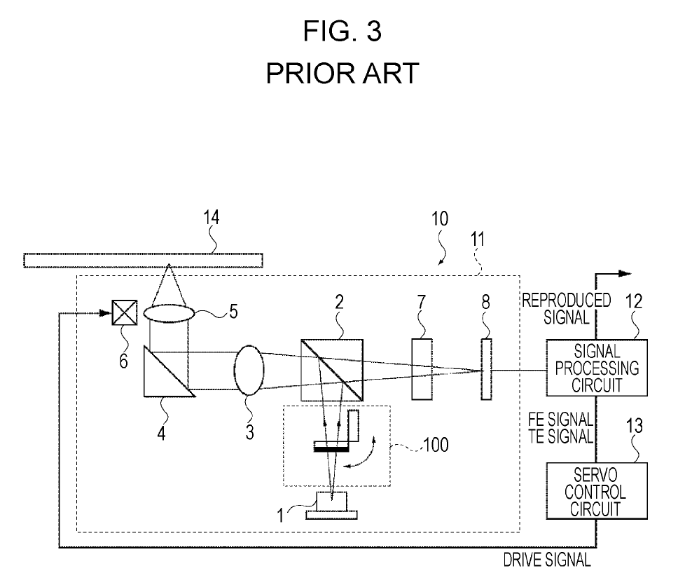

FIGS. 4A and 4B illustrate the structure of a light quantity adjusting unit in the related art.

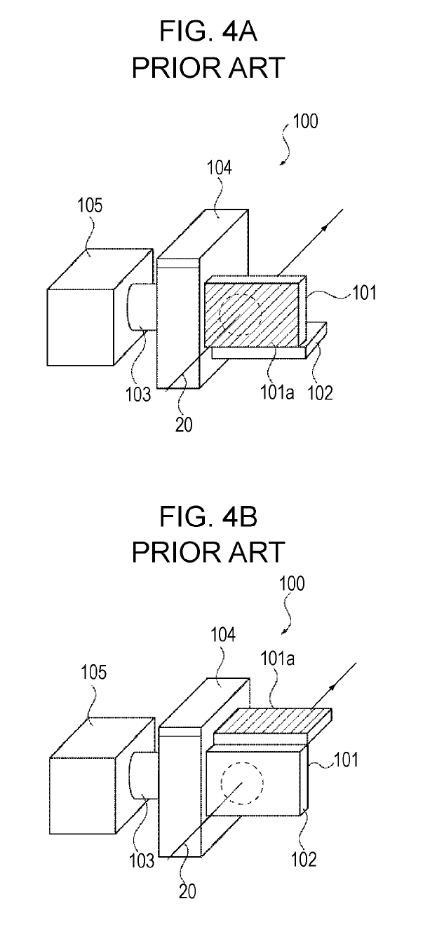

### DESCRIPTION OF THE EMBODIMENTS

An exemplary embodiment of the present invention will be described in detail with reference to the drawings.

### Exemplary Embodiment

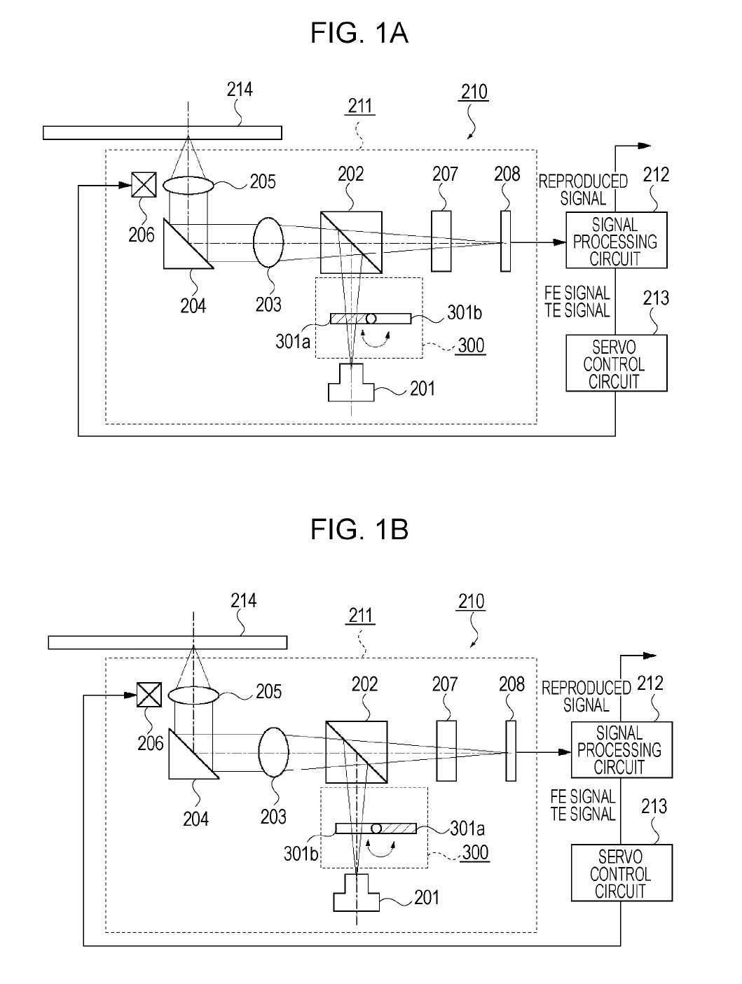

FIGS. 1A and 1B are each a functional block diagram of an information recording and reproducing apparatus (hereinafter referred to as an “optical disc drive apparatus 210”) according to the exemplary embodiment of the present invention. The optical disc drive apparatus 210 includes an optical pickup apparatus 211, a signal processing circuit 212, and a servo control circuit 213.

First, the operation of the optical disc drive apparatus 210 is summarized below. The optical pickup apparatus 211 radiates a light beam toward an optical disc 214 and detects light reflected from the optical disc 214. Further, the optical pickup apparatus 211 outputs a light quantity signal depending on the detected position of the reflected light and the quantity of the detected light. On the basis of the light quantity signal output from the optical pickup apparatus 211, the signal processing circuit 212 generates and outputs, for example, a focusing error (FE) signal representing a focused state of the light beam on the optical disc 214, and a tracking error (TE) signal representing the positional relationship between a focused position of the light beam and a track on the optical disc 214. The FE signal and the TE signal are collectively called servo signals. The servo control circuit 213 generates and outputs a drive signal on the basis of the servo signals. The drive signal is input to an actuator coil 206 (described later) of the optical pickup apparatus 211, whereupon the position of an objective lens 205 is adjusted. As a result, the focus of the light beam radiated toward the optical disc 214 is controlled in order to keep the light beam from departing from a recording layer.

In the state where the focus of the light beam is controlled to be kept from departing from the recording layer, the signal processing circuit 212 outputs a reproduced signal on the basis of the light quantity signal. The reproduced signal represents data written to the optical disc 214. As a result, data read from the optical disc 214 can be realized. Also, data can be written to the optical disc 214 by setting the optical power of the light beam to be greater than that necessary for reproducing.

The construction of the optical pickup apparatus 211 will be described below.

The optical pickup apparatus 211 includes an optical source 201, a light quantity adjusting mechanism 300, a beam splitter 202, a collimator lens 203, a mirror 204, the objective lens 205, the actuator coil 206, a multi-lens 207, and a photodiode 208.

The light source 201 is a GaN-based semiconductor laser emitting blue light. The light source 201 emits, toward the recording layer on the optical disc 214, coherent light for reading and writing data.

The light quantity adjusting mechanism 300 changes the optical power of the light beam emitted from the light source 201, which is in a state of producing higher optical power and holding quantum noise at a lower level, to a proper value by changing the light transmittance of the light quantity adjusting mechanism 300. In other words, the light quantity adjusting mechanism 300 utilizes the fact that, in a general semiconductor laser, as the laser, emits a light beam with higher optical power, a rate of quantum noise in the light beam decreases.

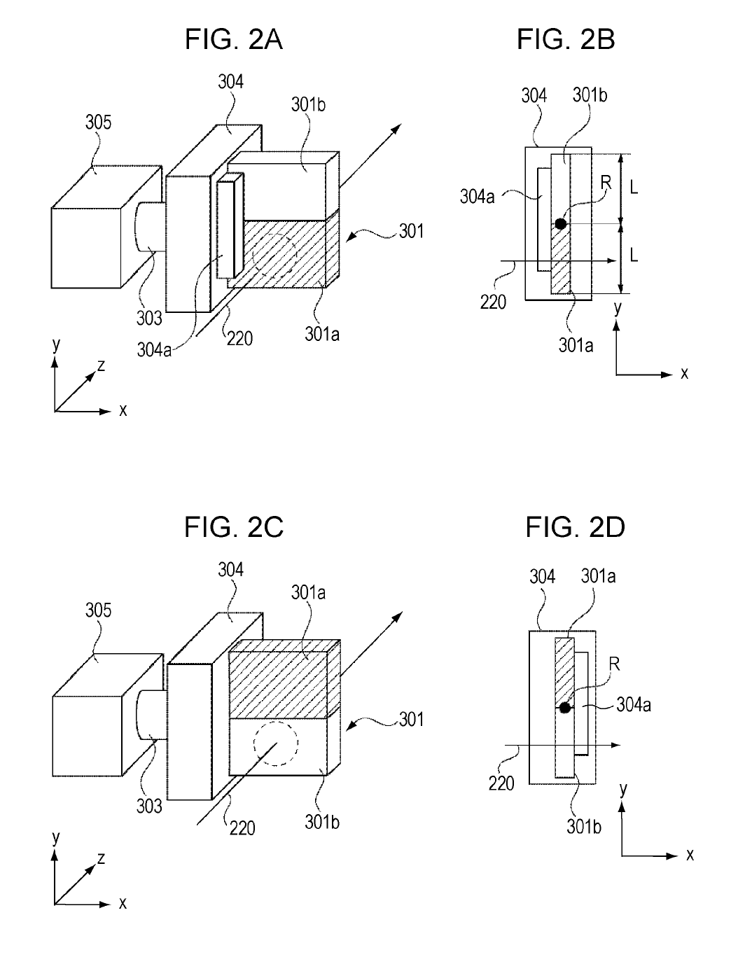

The detailed construction of the light quantity adjusting mechanism 300 will be described with reference to FIGS. 2A to 2D.

The light quantity adjusting mechanism 300, in the exemplary embodiment of the present invention, includes two transmission portions having different transmittances, i.e., a first transmission portion 301a having a first transmittance and a second transmission portion 301b having a second transmittance. The light quantity adjusting mechanism 300 rotates those two transmission portions, such that one of them is inserted into an optical path. Thus, the optical power of the light beam outgoing from the objective lens 205 can be changed relative to the optical power of the light beam emitted from the light source 201.

FIG. 2A is a perspective view of the light quantity adjusting mechanism 300 when a light beam 220 passes through the first transmission portion 301a of the light quantity adjusting mechanism 300, and FIG. 2B is a side view in the same state as that shown in FIG. 2A. FIG. 2C is a perspective view of the light quantity adjusting mechanism 300 when the light beam 220 passes through the second transmission portion 301b of the light quantity adjusting mechanism 300, and FIG. 2D is a side view in the same state as that shown in FIG. 2C. The optical beam 220 advances in the direction denoted by an arrow. An area indicated by broken circles in FIGS. 2A and 2C represents an effective area (described later) of the light beam 220 entering the transmission portion.

The light quantity adjusting mechanism 300 includes a transmission element 301 having the first transmission portion 301a and the second transmission portion 301b formed therein, a rotation shaft 303, a support element 304, and a rotating unit 305 (e.g., a stepping motor). In the exemplary embodiment, the transmission element 301 is formed of a single member, e.g., one flat glass plate. Therefore, the first transmission portion 301a and the second transmission portion 301b can be formed on the same plane. The first transmission portion 301a is formed by vapor-depositing an optical filter film having a transmittance of 50% on an area of the transmission element 301, which is positioned on the same side as an incident surface of the light beam 220 and which has a length L in the direction of the y-axis shown in FIGS. 2B and 2D, so as to cover the effective area of the light beam 220. The optical power of the light beam passing through the first transmission portion 301a is thereby attenuated. On the other hand, the optical filter film is not vapor-deposited on an area of the transmission element 301, which is positioned adjacent to the first transmission portion 301a in the direction of the y-axis in a plane parallel to the xy-plane and including the optical filter film of the first transmission portion 301a, and which has the same length L as the first transmission portion 301a. The second transmission portion 301b allows the light beam 220 to pass through it, substantially maintaining the light quantity of the light beam.

The support element 304 supports the transmission element 301 to be rotatable about the rotation shaft 303. In the exemplary embodiment, the support element 304 has a stopper 304a integrally formed thereon to restrict the position of the transmission element 301 in the direction of an optical axis (i.e., in the direction of a z-axis). The transmission element 301 is fixed in abutment against the stopper 304a.

As indicated by point R in FIGS. 2B and 2D, the rotation shaft 303 is rotated about point R, which is positioned in the yz-plane at the boundary between the first transmission portion 301a and the second transmission portion 301b, at the center of the transmission element 301, in the direction of the z-axis. In other words, a center axis of the rotation shaft 303 is positioned in the yz-plane outside the effective area of the light beam 220, and is extended perpendicularly to the direction of the optical axis of the light beam 220. The rotating unit 305 rotates the transmission element 301 about the rotation shaft 303.

While the rotation shaft 303 in the exemplary embodiment is provided, by constituting a rotation shaft of the support element 304 and a rotation shaft of the rotating unit 205 as a single shaft, a speed reducing mechanism made of a gear, etc., can be disposed between the respective rotation shafts.

With the structure described above, the volume occupied by the transmission element 301, when it is rotated, can be minimized.

By operating the rotating unit 305 to rotate the transmission element 301 about the rotation shaft 303, the light quantity adjusting mechanism 300 can selectively take a state of allowing the light beam 220 to pass through the first transmission portion 301a (FIGS. 2A and 2B) or a state of allowing the light beam 220 to pass through the second transmission portion 301b (FIGS. 2C and 2D).

Referring to FIG. 1 again, the beam splitter 202 separates the light beam emitted from the light source 201. The collimator lens 203 converts the light beam emitted from the light source 201 to parallel light. The mirror 204 reflects the incident light beam to be directed toward the optical disc 214. The objective lens 205 focuses the light beam onto the recording layer of the optical disc 214. The actuator coil 206 changes the position of the objective lens 205, in a direction perpendicular to the optical disc 214 or in a direction parallel to the optical disc 214, depending on a level of the applied drive signal. The multi-lens 207 focuses the light beam onto the photodiode 208. The photodiode 208 receives the light beam reflected by the recording layer of the optical disc 214 and converts the received light beam to an electrical signal (light quantity signal) corresponding to the light quantity of the received light beam. The photodiode 208 may include a plurality of light-receiving devices. The signal processing circuit 212 receives the light quantity signal and generates the FE signal and the TE signal by additionally utilizing information indicating from which one of the light-receiving devices the light quantity signal is output.

The operations of the optical disc drive apparatus 210 for reading and writing data will be described below. It is here assumed that, when the optical disc 214 has two recording layers, the transmittance of one recording layer positioned nearer to the objective lens 205 is set to about 50%. In such a case, therefore, the intensity of the optical power required for recording and reproducing data on and from the optical disc having two recording layers is about twice that required for the optical disc having one recording layer. Thus, the following description is made assuming that the optical pickup apparatus 211 of the exemplary embodiment has the function of selectively changing the intensity of the optical power depending on whether the optical disc 214 has one or two recording layers.

First, the light source 201 emits a light beam having a predetermined intensity of optical power. At that time, the light quantity adjusting mechanism 300 is assumed, as shown in FIG. 1A, to take the state where the light beam passes through the first transmission portion 301a. The light beam outgoing from the light quantity adjusting mechanism 300 is reflected by the beam splitter 202, converted to parallel light by the collimator lens 203, and reflected by the mirror 204. Then, the light beam is focused by the objective lens 205 onto the recording layer of the optical disc 214. The reflected light from the recording layer passes through the optical pickup apparatus 211 and enters the photodiode 208. The signal processing circuit 212 determines the number of recording layers of the optical disc 214 depending on the magnitude of the resulting light quantity signal. The process of determining the number of recording layers of the optical disc 214 can also be performed by using other various methods. For example, identification information, for specifying the number of recording layers, is recorded in an inner peripheral area of the optical disc 214 in a manufacturing stage, and the identification information is read as a reproduced signal to specify the number of recording layers. As an alternative, taking into account the fact that when the laser beam is irradiated to recording media, the intensity of reflected light differs depending on the types of the recording media, the signal processing circuit 212 determines the number of recording layers by detecting the intensity of the reflected light. Further, when the optical disc 214 is loaded in a state contained in a cartridge, the number of recording layers can be determined by checking the shapes of cartridges, which differ from each other, depending on the types of the optical discs 214. The number of recording layers of the optical disc 214 can, therefore, be detected by utilizing optical characteristics and/or physical characteristics of the optical disc loaded in place.

When it is determined that the optical disc 214 has one recording layer, the light quantity adjusting mechanism 300 is operated to rotate the transmission element 301 such that, as shown in FIG. 1A, the first transmission portion 301a is positioned to perpendicularly intersect the optical axis. Therefore, the light beam entering the first transmission portion 301a passes through it after attenuating the optical power to about 50%. Stated another way, the optical power of the light beam outgoing from the objective lens 205 can be adjusted and quantum noise can be reduced by increasing the optical power of the light beam emitted from the light source 201 and by causing the emitted light beam to pass through the first transmission portion 301a.

On the other hand, when it is determined that the optical disc 214 has two recording layers, the light quantity adjusting mechanism 300 is operated to rotate the transmission element 301 such that, as shown in FIG. 1B, the second transmission portion 301b is positioned to perpendicularly intersect the optical axis. Therefore, the light beam entering the second transmission portion 301b passes through it without substantially attenuating the optical power. Stated another way, since the optical power of the light beam required for the optical disc 214 having two recording layers is, as described above, about twice that required for the optical disc 214 having one recording layer, the light beam originally emitted from the light source 201 is in a state where the quantum noise is reduced.

When data is written, the state of the recording layer, in an area where a light spot is formed, is changed, depending on the substance of the data. When data is read, the light beam is reflected at a reflectivity that depends on the state of the recording layer of the optical disc 214. The light beam reflected by the recording layer passes through the objective lens 205 again, and it is reflected by the mirror 204. After passing through the collimator lens 203 and then the multi-lens 207, the light beam is focused onto the photodiode 208. As a result, the photodiode 208 generates and outputs the light quality signal. On the basis of the light quantity signal, the signal processing circuit 212 generates the reproduced signal representing the substance of the written data, the focusing error signal, the tracking error signal, etc.

According to the exemplary embodiment, the first transmission portion 301a and the second transmission portion 301b can be formed integrally with the transmission element 301. Also, the transmission element 301 can be disposed abutting against the stopper 304a on the support element 304 so as to be properly positioned in the direction of the optical axis. Unlike the related art, therefore, the first transmission portion 301a and the second transmission portion 301b have no relative angular variation between them. It is possible, therefore, to reduce a deviation of the optical axis, which is otherwise caused by an angular deviation of the transmission element 301 relative to the optical axis of the light beam 220, passing through the transmission element 301. As a result, a deviation of the position on the photodiode 208, where the light beam reflected by the recording layer of the optical disc 214 is focused can be reduced in comparison with that in the related art.

Hence, deterioration in quality of the servo signals, the reproduced signal, and the recording signal are reduced, without increasing the number of parts. Further, since the transmission element is constituted as a one-piece member, the number of parts is reduced in comparison with that in the related art.

While, in the exemplary embodiment, the stopper 304a for properly positioning the transmission element 301 in the direction of the optical axis, is formed to extend in the direction of the y-axis, as illustrated, the exemplary embodiment of the present invention is not limited to that arrangement. For example, the stopper 304a can also be formed outside the effective area of the light beam 220 to extend in the direction of the x-axis at the boundary between the first transmission portion 301a and the second transmission portion 301b. Also, instead of forming the stopper 304a to project from the support element 304, as illustrated, the surface of the support element 304 can be recessed in the direction of the x-axis, such that the transmission element 301 is inserted in the recess.

As another example, a fixing jig, adjusted in its position relative to a reference surface of the support element 304, can also be used, without using the stopper 304a for properly positioning the transmission element 301 in the direction of the optical axis. In such a case, the positions of the transmission element 301 and the support element 304 are adjusted by using the fixing jig, and contact surfaces of the transmission element 301 and the support element 304 are fixed to each other with surface bonding.

As another example, the first transmission portion 301a and the second transmission portion 301b can be constituted by separate optical elements in the form of flat plates. In such a case, although the above-described advantage of reducing the number of parts cannot be obtained, the separate optical elements can be disposed in states abutting against the stopper 304a on the support element 304, so as to be properly positioned in the direction of the optical axis. Thus, the first transmission portion 301a and the second transmission portion 301b have no relative angular variation between them, and the advantage of the exemplary embodiment of the present invention can be similarly obtained.

Further, when the optical elements in the form of flat plates are combined and bonded to each other by using the above-mentioned fixing jig, there is a possibility that the first transmission portion 301a and the second transmission portion 301b deviate from the same plane by a small amount in the direction of the z-axis, for example. Even in that case, however, the advantage of the exemplary embodiment of the present invention can, of course, be similarly obtained by reducing the relative angular variation between the first transmission portion 301a and the second transmission portion 301b compared to the related art. The fixing jig used in that case is desirably constituted such that the first transmission portion 301a and the second transmission portion 301b are abutted against a single jig surface, like the stopper 304a shown in FIG. 2.

While, in the exemplary embodiment, the optical filter film is formed on the incident surface of the light beam 220 of the transmission element 301, it can be formed on the emergent surface thereof instead.

In the exemplary embodiment, the quantity of the transmitting light is changed by vapor-depositing, on the transmission element 301, the optical filter film having a light attenuating effect. The quantity of the transmitting light, however, can also be changed, for example, by forming a metallic film or a dielectric film, which is made of chromium, chromium oxide, silicon oxide, TiO₂, Al₂O₃, MgF, etc., or a combined film of two or more selected from among those materials, on the surface of the optical element with coating or sputtering. Alternatively, a film-like attenuating element can be bonded to the transmission element 301, or the film-like attenuating element can be itself used as the first transmission portion 301a. In such a case, the lengths of respective optical paths in the first transmission portion 301a and the second transmission portion 301b should be set equal to each other in order to prevent defocusing of the reflected light from the optical disc 214 on the light receiving surface of the photodiode 208, which is otherwise caused due to the difference in thickness between the first and second transmission portion 301a and 301b of the transmission element 301. The film-like attenuating element can generally be formed by mixing a dye in a base material, such as gelatin or acetate.

While the transmission element 301 is made of glass in the exemplary embodiment, it can also be made of a resin material.

In addition, the quantity of the transmitting light can be changed by using a material as the first transmission portion 301a, which has a lower transmittance than that of the second transmission portion 301b.

Alternatively, the light quantity of the light beam passing through the first transmission portion 301a can be attenuated by forming a nano-structure having a finely textured shape on one surface of the first transmission portion 301a, which is positioned perpendicularly to the optical axis. As one practical example, the quantity of the transmitting light beam can be attenuated by forming a diffraction grating on one surface of the first transmission portion 301a, which is positioned perpendicularly to the optical axis. In such a case, the quantity of primary light having passed through the diffraction grating is changed, and the primary light is introduced to the optical disc 214. Of course, the advantage of the exemplary embodiment of the present invention can also be obtained by forming the one surface of the first transmission portion 301a into a shape other than the diffraction grating, so long as a similar attenuating effect can be obtained with the formed shape.

While the light quantity is adjusted in the exemplary embodiment by selecting one of the first transmission portion 301a attenuating the transmitting light and the second transmission portion 301b not attenuating the transmitting light, an optical filter having a different transmittance from that of the optical filter coated on the first transmission portion 301a can be coated on the second transmission portion 301b. With such an arrangement, even when the optical disc 214 having two recording layers is used, the light beam can be irradiated from the light source 201, with optical power that is increased, to be able to further reduce the quantum noise.

While the exemplary embodiment uses a blue semiconductor laser as the light source, a red semiconductor laser, or still another light source having a different wavelength ranging from green to ultraviolet ray ranges, can also be used.

Further, in the exemplary embodiment, the light quantity adjusting mechanism 300 selectively changes the light quantity of the light beam between when the information recording medium has one recording layer and when it has two recording layers. However, when the optical disc drive apparatus 10 is capable of writing and/or reading data to and from information recording media having two or more recording layers, the light quantity of the light beam can likewise be selectively changed depending on the number of recording layers of the optical disc. In such a case, the light quantity of the light beam can be changed in multiple stages, for example, by mounting the light quantity adjusting mechanism 300 of the exemplary embodiment in plural along the optical axis.

In addition, the light quantity of the light beam can be selectively changed between the mode of reading data and the mode of writing data, in a similar manner.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

Except as otherwise discussed herein, the various components shown in outline or in block form in the Figures are individually well known and their internal construction and operation are not critical either to the making or using or to a description of the best mode of the invention.

This application claims the benefit of Japanese Application No. 2007-319853 filed Dec. 11, 2007, which is hereby incorporated by reference herein in its entirety.

What is claimed is:

1. A light quantity adjusting apparatus to adjust a light quantity of a light beam emitted from a light source, the apparatus comprising:
a transmission element, including a first transmission portion, formed on a plane, having a first transmittance, and a second transmission portion, formed on the same plane as that of the first transmission portion, having a second transmittance;
a support element to support the transmission element; and
a rotation shaft connected to said support element, having a center axis extending in a direction perpendicular to an optical axis of the light beam, to rotate said transmission element, supported by said support element, about the center axis, to insert into a path of the light beam one of the first transmission portion and the second transmission portion, for adjusting the light quantity of the light beam passing through a respective transmission portion.

2. The apparatus according to claim 1, wherein the center axis of said rotation shaft is positioned at a boundary between the first transmission portion and the second transmission portion.

3. The apparatus according to claim 1, wherein the first transmission portion and the second transmission portion are formed on a single member.

4. The apparatus according to claim 1, wherein the first transmission portion has an optical filter film to adjust the light quantity of the light beam passing through the first transmission portion.

5. The apparatus according to claim 4, wherein the first transmittance is 50%.

6. The apparatus according to claim 4, wherein the second transmission portion is free from an optical filter film to maintain the light quantity of the light beam passing through the second transmission portion.

7. The apparatus according to claim 1, wherein the support element includes a stopper to restrict said transmission element from being positioned parallel to the direction of the optical axis.

8. An optical pickup apparatus comprising:
(a) a light source for emitting a light beam;
(b) a light quantity adjusting mechanism to adjust a light quantity of a light beam emitted from said light source, wherein said light quantity adjusting mechanism comprises:
(i) a transmission element, including a first transmission portion, formed on a plane, having a first transmittance, and a second transmission portion, formed on the same plane as that of the first transmission portion, having a second transmittance;
(ii) a support element to support said transmission element; and
(iii) a rotation shaft connected to said support element, having a center axis extending in a direction perpendicular to an optical axis of the light beam, to rotate said transmission element, supported by said support element, about the center axis, to insert into a path of the light beam one of the first transmission portion and the second transmission portion, for adjusting the light quantity of the light beam passing through a respective transmission portion; and
(c) an objective lens to focus the light beam, having the adjusted light quantity, from said light quantity adjusting mechanism onto an information recording medium.

9. The optical pickup apparatus according to claim 8, wherein the center axis of said rotation shaft is positioned at a boundary between the first transmission portion and the second transmission portion.

10. The optical pickup apparatus according to claim 8, wherein the first transmission portion and the second transmission portion are formed on a single member.

11. The optical pickup apparatus according to claim 8, wherein the first transmission portion has an optical filter film to adjust the light quantity of the light beam passing through the first transmission portion.

12. The optical pickup apparatus according to claim 11, wherein the first transmittance is 50%.

13. The optical pickup apparatus according to claim 11, wherein the second transmission portion is free from an optical filter film to maintain the light quantity of the light beam passing through the second transmission portion.

14. The optical pickup apparatus according to claim 8, wherein the support element includes a stopper to restrict said transmission element from being positioned parallel to the direction of the optical axis.

15. The optical pickup apparatus according to claim 8, further comprising a photodiode to receive a light beam reflected from the information recording medium and to convert the received light beam to a light quantity signal output.

16. An apparatus for effecting at least one of recording and reproducing information, said apparatus comprising:
(a) a light source for emitting a light beam;
(b) a light quantity adjusting mechanism to adjust a light quantity of a light beam emitted from said light source, wherein said light quantity adjusting mechanism comprises:
(i) a transmission element, including a first transmission portion, formed on a plane, having a first transmittance, and a second transmission portion, formed on the same plane as that of the first transmission portion, having a second transmittance;
(ii) a support element to support said transmission element; and
(iii) a rotation shaft connected to said support element, having a center axis extending in a direction perpendicular to an optical axis of the light beam, to rotate said transmission element, supported by said support element, about the center axis, to insert into a path of the light beam one of the first transmission portion and the second transmission portion, for adjusting the light quantity of the light beam passing through a respective transmission portion;
(c) an objective lens to focus the light beam, having the adjusted light quantity, from said light quantity adjusting mechanism onto an information recording medium;
(d) a photodiode to receive a light beam reflected from the information recording medium and to convert the received light beam to a light quantity signal output; and
(e) a signal processing circuit configured to output, based on the light quantity signal output, a focusing error signal, representing a focused state of a light beam on the information recording medium, and a tracking error signal, representing a positional relationship between a focused position of the light beam and a track on the information recording medium.

17. The apparatus according to claim 16, wherein the center axis of said rotation shaft is positioned at a boundary between the first transmission portion and the second transmission portion.

18. The apparatus according to claim 16, wherein the first transmission portion and the second transmission portion are formed on a single member.

19. The apparatus according to claim 16, wherein the first transmission portion has an optical filter film to adjust the light quantity of the light beam passing through the first transmission portion.

20. The apparatus according to claim 19, wherein the first transmittance is 50%.

21. The apparatus according to claim 19, wherein the second transmission portion is free from an optical filter film to maintain the light quantity of the light beam passing through the second transmission portion.

22. The apparatus according to claim 16, wherein the support element includes a stopper to restrict said transmission element from being positioned parallel to the direction of the optical axis.
